(19) United States
(12) Patent Application Publication
(10) Pub. No.: US 2015/0263470 A1
(43) Pub. Date: Sep. 17, 2015

(54) FOREIGN MATTER REMOVAL METHOD AND APPARATUS FOR CONNECTOR

(71) Applicant: Sumitomo Wiring Systems, Ltd., Yokkaichi (JP)

(72) Inventors: Tomoya Itou, Yokkaichi (JP); Yukinori Saka, Wolfsburg (DE); Harald Lutsch, Wolfsburg (DE)

(21) Appl. No.: 14/644,275

(22) Filed: Mar. 11, 2015

(30) Foreign Application Priority Data
Mar. 12, 2014 (JP) 2014-048846

(51) Int. Cl. H01R 43/00; B24C 1/00

(52) U.S. Cl. CPC H01R 43/002; B24C 1/003

(57) ABSTRACT

A connector (C) in which pin-like terminal fittings (6) project from the back surface of a housing (1) is held in a setting tool (9) including an opening (13). The connector (C) then is conveyed to an operation position together with the setting tool (9). At the operation position, a suction device (16) is located to communicate with the opening (13) from below and a nozzle (21) is located above the opening (13). Cooled dry ice fine particles are blown toward the housing (1) and the terminal fittings (6) from the nozzle (21). Foreign matters with reduced adhering forces by being cooled come off from the adhering surfaces and are sucked and collected by the suction device (16).

### BACKGROUND

1. Field of the Invention

The present invention relates to foreign matter removal method and apparatus for connector.

2. Description of the Related Art

Japanese Unexamined Patent Publication No. 2004-199974 discloses a press-fit type terminal mounted in housing of a connector mounted on a printed board in some cases. The press-fit terminal projects back from the rear surface of the housing. Further, an opening is formed on a tip part of the press-fit terminal and a part formed with this opening is press-fit into a through hole of a printed board to be electrically connected to a conductive path formed on the printed board. The opening in the press-fit terminal is formed by punching. Thus, very small metal pieces produced when the opening is formed may remain to adhere to the terminal. These metal pieces may drop onto the board and cause a short circuit between circuits formed on the board when the connector is mounted on the printed board. Accordingly, air is blown to the periphery of the terminal fitting projecting from the housing to remove such metal pieces before the connector is mounted on the board.

However, there are cases where metal pieces are not removed by blowing air and minute metal pieces easily remain. Accordingly, a visual inspection is made before shipment as a finished product. However, metal pieces can be overlooked despite the time-consuming visual inspection.

The invention was completed based on the above situation and provides a foreign matter removal method and apparatus for capable of effectively removing foreign matter produced in a connector production process.

### SUMMARY

The invention relates to a foreign matter removal method for a connector in which at least one terminal fitting projects from a connector housing. The method includes setting the connector housing in a setting tool including an opening substantially corresponding to a suction device while causing a tip part of the terminal fitting projecting from the connector housing to face the opening. The method proceeds by injecting cooled fine particles toward the terminal fitting and/or the connector housing from a nozzle while the suction device is driven.

The terminal fitting may project in a projecting direction from a back surface of the housing and may be bent at an angle, preferably substantially normally in a distal direction at an intermediate position. The nozzle may be displaced along a bending direction of the terminal fitting in the injection step.

The fine particles may be dry ice.

The connector may be set on the setting tool so as to be held thereon by holding at least one flange of the housing on at least one mounting wall of the setting tool.

Plural connectors may be set in plural connector holding portions of the setting tool.

The nozzle may be moved while injecting the cooled fine particles toward the terminal fitting and/or the connector housing. The invention also relates to a foreign matter removal apparatus for a connector in which at least one terminal fitting projects from a connector housing. The apparatus has a setting tool capable of holding the housing. The setting tool may be an opening toward which a tip part of the terminal fitting projecting form the connector housing faces when the connector housing is held. The apparatus also has an injection device including at least one nozzle configured to face the terminal fitting and inject cooled fine particles toward the terminal fitting and/or the connector housing. The apparatus further has a suction device corresponding to the opening and capable of sucking the fine particles injected from the nozzle.

The terminal fitting may project in a projecting direction from a back surface of the connector housing and may be bent, preferably substantially substantially normally, in a distal direction at an intermediate position. The apparatus may move the nozzle along a bending direction of the terminal fitting while the injection device injects the cooled fine particles toward the terminal fitting and/or the connector housing.

The apparatus may be configured to inject dry ice as the fine particles. Dry ice evaporates quickly, and hence a drying step is not required.

The setting tool may have a mounting wall configured to hold a flange of the connector.

According to the invention, the cool fine particles collides with any foreign matter on the terminal fitting and the impact forces separate the foreign matter from an adhering surface. Alternatively or additionally, the foreign matter is displaced on the adhering surface due to thermal shrinkage caused by cooling. Thus, an adhering force of the foreign matter to the adhering surface is reduced and the foreign matter is separated. The separated foreign matter is sucked and collected through the opening of the setting tool by the suction device. In this way, the foreign matter can be removed effectively from the connector.

These and other features and advantages of the invention will become more apparent upon reading the following detailed description of preferred embodiments and accompanying drawings.

### BRIEF DESCRIPTION OF THE DRAWINGS

FIG. 1 is a perspective view showing a state where a connector and a setting tool are separated.

FIG. 2 is a front view showing a foreign matter removal line for connector.

FIG. 3 is a rear view showing a foreign matter removal operation by a foreign matter removal apparatus.

FIG. 4 is a side view in section showing the foreign matter removal operation.

### DETAILED DESCRIPTION

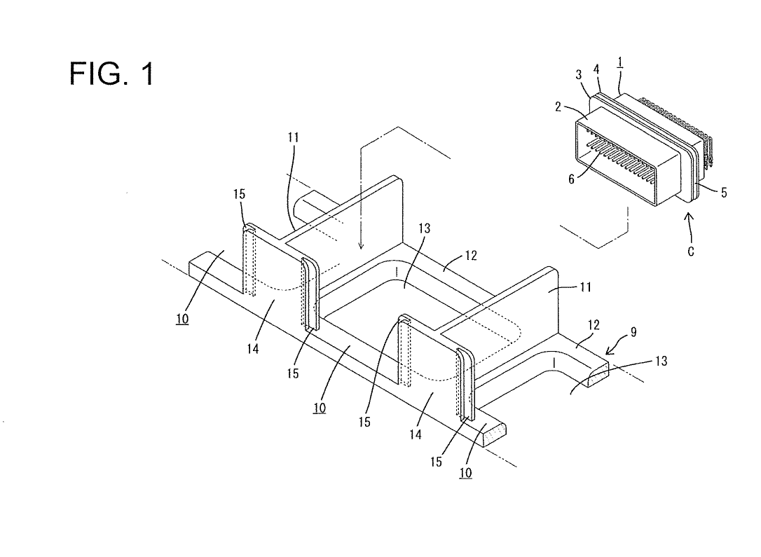

As shown in FIG. 1, a connector C includes a housing 1 made of synthetic resin. The housing 1 includes a rectangular tubular receptacle 2 that opens forward. Flanges 3, 4 bulge out on a back part of the outer peripheral surface of the receptacle 2 and are spaced apart in a front-back direction. A mounting groove 5 is formed over the entire periphery between the two flanges 3, 4 and can fit to the opening edge of a mounting window (not shown) formed in an ECU case when the connector C is mounted on the ECU case.

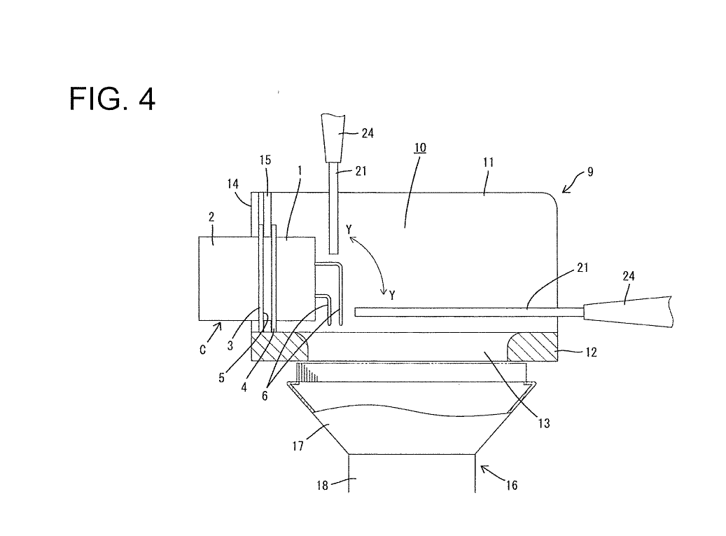

Pin-like terminal fittings 6 are press-fit through a back wall in the receptacle 2 by press-fitting and are arranged side by side in a width direction in upper and lower stages in the receptacle 2. The other ends of the respective terminal fittings 6 are bent substantially perpendicularly down after projecting substantially horizontally out from the rear surface of the housing 1. As shown in FIG. 4, the terminal fittings 6 in the lower stage are bent near the back surface of the housing 1 and those in the upper stage are bent at a position more distant from the back surface of the housing 1. However, the corresponding terminal fittings 6 in the upper and lower stages are aligned in phase in the width direction. That is, the corresponding terminal fittings 6 in the upper and lower stages are arranged in an overlapping manner when viewed from behind.

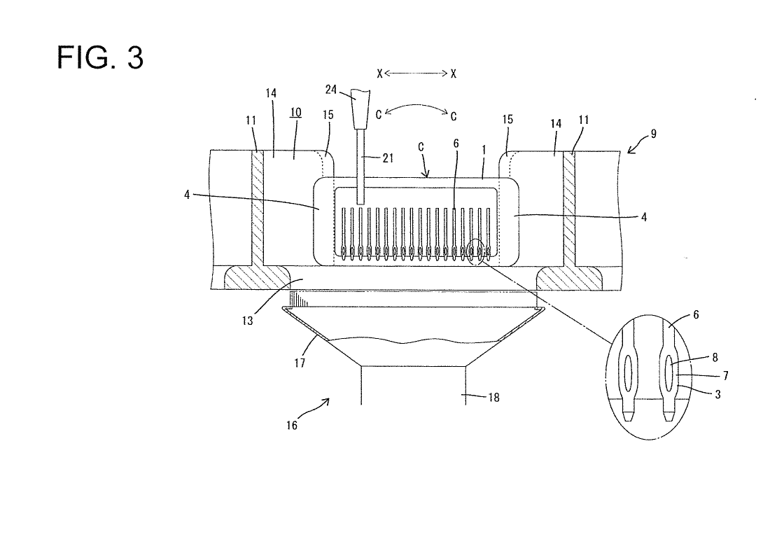

As shown in FIG. 3, a press-fit portion 7 is formed on the other end of each terminal fitting 6 and is to be press-fit into a through hole of a printed board. The press-fit portion 7 is wider than the other part and has a needle eye 8.

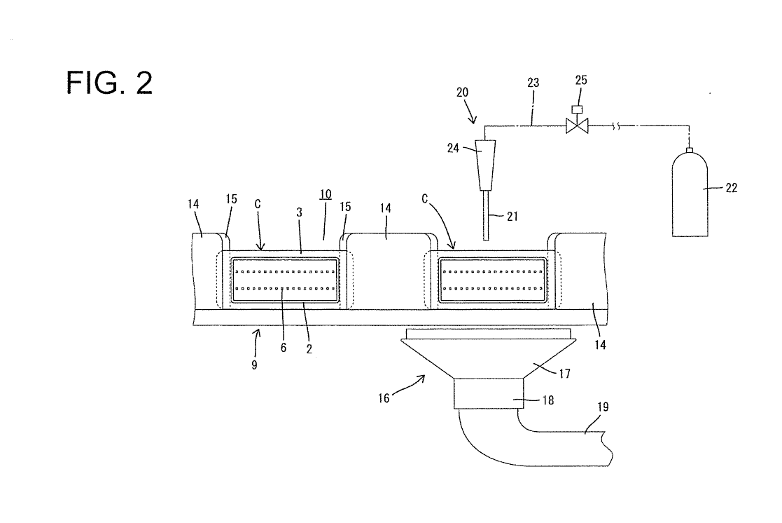

As shown in FIG. 1, a setting tool 9 is a continuous body extending in one direction. The setting tool 9 is placed on an unillustrated conveyor along a longitudinal direction and can be moved intermittently in a conveying direction (left in FIG. 2) of the conveyor.

Connector holding portions 10 are provided side by side in the setting tool 9 along the longitudinal direction and partition walls 11 having a height sufficiently longer than the height of the housing 1 stand between adjacent connector holding portions 10 to partition between the adjacent connector holding portions 10. Each connector holding portion 10 includes a main body frame 12 for supporting the connector C. The main body frame 12 is substantially rectangular and an opening 13 opens in a central part.

Two front walls 14 stand on the front edge of the main body frame 12. Each front wall 14 bulges out a substantially equal distance in the width direction from the front end of the partition wall 11. A predetermined clearance is formed between facing edges of the front walls 14 in each connector holding portion 10. Specifically, the clearance is slightly narrower than the entire widths of the flanges 3, 4 when the connector C is viewed from the front. The front walls 14 are connected to the partition walls 11 and have the same height as the partition walls 11. Bulging walls 15 bulge out at positions of the facing edges of the front walls 14 near the opening 13. The bulging walls 15 are formed substantially over the entire height range of the front walls 14 and insertable into the mounting groove 5 of the housing 1. Thus, the connector C is held in each connector holding portion 10 by sliding the connector C down while a lower part of the mounting groove 5 of the housing 1 and upper end parts of the corresponding bulging walls 15 are aligned. In this way, the flanges 3, 4 sandwich the bulging walls 15 from the front and rear to hold the connector C in the front-back direction. Lower parts of all the terminal fittings 6 face the opening 13 from above when the connector C is held in each connector holding portion 10, as shown in FIG. 4.

A suction device 16 is installed at a predetermined intermediate position of a conveyance path by the conveyor and is below the setting tool 9, as shown in FIG. 2. The suction device 16 includes a collecting portion 17 widened toward an upper side and capable of collecting foreign matter. The collecting portion 17 is aligned successively to communicate with each opening 13 of the setting tool 9 every time the conveyor stops. The collecting portion 17 is connected to a suction drive source (not shown) via a filter 18 and a duct 19.

The injection device 20 includes at least one nozzle 21 for injecting dry ice fine particles to the housing 1 and the terminal fittings 6 projecting out from the housing 1. The nozzle 21 is movable (e.g. free to extend and contract) and is connected to a supply source 22 for liquefied gas (particularly liquefied carbon dioxide or nitrogen) via at least one supply pipe 23, as shown in FIG. 4. An electromagnetic on-off valve 25 is disposed at an intermediate position of the supply pipe 23.

The nozzle 21 is arranged to face the suction device 16 from above and an injection port at the tip of the nozzle 21 is directed substantially toward the terminal fittings 6 when the connector C is set in the connector holding portion 10. Further, the nozzle 21 is connected to a robot arm 24 and is displaceable in three-dimensional directions in this embodiment. Specifically, the nozzle 21 makes a horizontal movement in an X-X direction shown in FIG. 3, a swinging movement in a C-C direction shown in FIG. 3 and a movement in a Y-Y direction along bent shapes of the terminal fittings 6 shown in FIG. 4 and is set to be able to make a composite movement of these movements during a foreign matter removal operation.

Foreign matter is removed by initially locating the connector C above each connector holding portion 10 in the setting tool 9. The lower part of the mounting groove 5 of the housing 1 and the upper end parts of the corresponding bulging walls 15 are aligned and the connector C is slid down. In this way, the flanges 3, 4 sandwich the corresponding bulging walls 15 from the front and rear to position the connector C in the front-back direction. As a result, the terminal fittings 6 that project from the back surface of the housing 1 face the opening 13 from above.

The unillustrated conveyor is moved intermittently to the left in FIG. 2 together with the setting tool 9 and the connector C that has been set in the setting tool 9. The conveyor is stopped for a predetermined time when the connector C is between the nozzle 21 and the collecting portion 17 of the suction device 16. Thereafter, the on-off valve 25 is opened and the liquefied gas (such as liquefied carbon dioxide or nitrogen) is supplied to the nozzle 21 via the supply pipe 23 from the supply source 22. The liquefied gas undergoes a quick pressure reduction in the supply pipe 23 to evaporate. The evaporated gas cools quickly by being deprived of evaporation heat. A part of the gas (e.g. carbon oxide or nitrogen) is solidified to become fine particles e.g. of dry ice (as an example of cooled fine particles). In this way, the fine particles of dry ice are injected together with the gas from the injection port at the tip of the nozzle 21 and are blown toward the housing 1 and the terminal fittings 6 projecting out from the housing 1.

The nozzle 21 is moved three-dimensionally by the robot arm 24 while the dry ice particles are injected from the nozzle 21. Thus, the nozzle 21 can blow the dry ice fine particles and the like thoroughly to the housing 1 and the entire length regions of all the terminal fittings 6 projecting from the housing 1. Specifically, as shown in FIG. 3, a region from one widthwise end to the other widthwise end is included in an injection region for the terminal fittings 6 projecting from the back of the housing 1 by a horizontal movement in the X-X direction. Further, the nozzle 21 makes a swinging movement in the C-C direction shown in FIG. 3, so that the terminal fittings 6 in the lower stage are not hidden by those in the upper stage and including the overlapping terminal fittings 6 in the lower stage in the injection region. Furthermore, the nozzle 21 includes a region over the entire lengths of the respective terminal fittings 6 in the injection region by a movement in the Y-Y direction along the bent shapes of the terminal fittings 6, as shown in FIG. 4.

Gas (e.g. carbon dioxide or nitrogen) and the cooled dry ice fine particles are blown to impact foreign matter adhering to the housing 1 or the terminal fittings 6. Thus, the foreign matter is separated from adhering surfaces by collision energy from the fine particles. Additionally, the foreign matter cools to shrink thermally and displace from the adhering surfaces.

The unillustrated suction drive source is driven during injection from the nozzle 21. Thus, a suction force is applied to a space behind the housing 1 through the opening 13 of the setting tool 9. In this way, the separated foreign matter is collected via the collecting portion 17 without being scattered around.

The conveyor is moved by one pitch a predetermined time after completion of the foreign matter removal operation for the connector C stopped at an operation position. Thus, the next connector C reaches the operation position, and the foreign matter removal operation is repeated at this operation position.

As described above, any foreign matter that adheres to the housing 1 or the terminal fittings 6 projecting from the housing 1 can be removed effectively by blowing the dry ice fine particles and the gas. Thus, the foreign matter, such as metal pieces, can be removed and a possibility of a short circuit between the terminal fittings can be dispelled reliably. Further, the suction force is applied by the suction device 16 during the foreign matter removal operation so that the foreign matters are not scattered around as the fine particles are blown.

Further, the cooled fine particles (particularly the dry ice fine particles and the like) can be blown thoroughly to the respective terminal fittings 6 projecting from the back surface of the housing 1 by moving the nozzle 21 in three-dimensional directions. Particularly, the dry ice fine particles and the like can be blown to the terminal fittings 6 in the lower stage overlapping with and hidden by the terminal fittings 6 in the upper stage by causing the nozzle 21 to make a swinging movement in the C-C direction.

The invention is not limited to the above described embodiment, and the following embodiments also are included in the scope of the invention.

Although an injection direction is changed by moving one nozzle 21 in the three-dimensional directions in the above embodiment, a plurality of nozzles 21 having different injection directions may be arranged.

The terminal fittings 6 are bent substantially perpendicularly behind the housing 1 in the above embodiment, but they may extend straight back.

The suction device 16 and the nozzle 21 are fixed and the setting tool 9 is conveyed intermittently by the conveyor. However, the suction device 16 and the nozzle 21 may be moved in synchronization while the setting tool 9 is fixed.

The both bulging walls 15 are inserted into the mounting groove 5 of the connector to hold the connector in the setting tool 9. However, other holding methods such as holding by resilient locks may be used.

The terminal fittings 6 are press fit in the above embodiment. However, other types of terminal may be used.

The terminal fittings 6 are substantially pin-like. However, the terminal fittings may have other shapes such as box-like, tab-like and/or blade-like shape.

### REFERENCE SIGNS

1 . . . connector housing
3, 4 . . . flange
6 . . . terminal fitting
9 . . . setting tool
10 . . . connector holding portion
13 . . . opening
15 . . . bulging wall (mounting wall)
16 . . . suction device
20 . . . injection device
21 . . . nozzle
24 . . . robot arm (movable arm)
C . . . connector

What is claimed is:

1. A foreign matter removal method for a connector (C) in which at least one terminal fitting (6) projects from a housing (1), comprising:
setting the housing (1) in a setting tool (9) including an opening (13) substantially corresponding to a suction device (16) while causing a tip of the terminal fitting (6) projecting from the housing (1) to substantially face the opening (13); and
injecting cooled fine particles toward the terminal fitting (6) and/or the housing (1) from a nozzle (21) while operating the suction device (16).

2. The foreign matter removal method of claim 1, wherein the terminal fitting (6) projects substantially in a projecting direction from a back surface of the housing (1) and is bent at an intermediate position, and the step of injecting cooled fine particles includes displacing the nozzle (21) along a bending direction of the terminal fitting (6).

3. The foreign matter removal method of claim 1, wherein the fine particles are dry ice.

4. The foreign matter removal method of claim 1, wherein the step of setting step the connector (C) on the setting tool (9) comprises holding at least one flange (3; 4) of the housing (1) on at least one mounting wall (15) on the setting tool (9).

5. The foreign matter removal method of claim 1, wherein the step of setting the housing (1) in a setting tool (9) comprises setting a plurality of connectors (C) in plural connector holding portions (10) of the setting tool (9).

6. The foreign matter removal method of claim 1, wherein the nozzle (21) is moved while injecting the cooled fine particles toward the terminal fitting (6) and/or the housing (1).

7. A foreign matter removal apparatus for a connector (C) having at least one terminal fitting (6) projecting from a housing (1), comprising:
a setting tool (9) configured for holding the housing (1) and formed with an opening (13) toward which a tip part of the terminal fitting (6) projecting form the connector housing (1) faces when the housing (1) is held;
an injection device (20) including at least one nozzle (21) configured to substantially face the terminal fitting (6) and inject cooled fine particles toward the terminal fitting (6) and/or the housing (1); and
a suction device (16) substantially corresponding with the opening (13) and capable of sucking the fine particles injected from the nozzle (21).

8. The foreign matter removal apparatus of claim 7, wherein the terminal fitting (6) projects from a surface of the connector housing (1) and is bent at an intermediate position, and the nozzle (21) is displaceable along a bending direction of the terminal fitting (6) while the injection device (20) injects the cooled fine particles toward the terminal fitting (6) and/or the connector housing (1).

9. The foreign matter removal apparatus of claim 7, wherein the nozzle (21) is provided on a movable arm (24) and is configured to be moved while injecting the cooled fine particles toward the terminal fitting (6) and/or the connector housing (1).

10. The foreign matter removal apparatus of claim 7, wherein the connector (C) comprises at least one flange (3; 4) and the setting tool (9) is configured to engage the flange.
